(19) United States
(12) Patent Application Publication
(10) Pub. No.: US 2006/0213384 A1
(43) Pub. Date: Sep. 28, 2006

(54) Sheet quality control device

(75) Inventors: Gerald Josef Reinhard, Sulzfeld (DE); Volkmar Rolf Schwitzky, Wurzburg (DE); Manfred Georg Stohr, Guntersleben (DE); Johannes Georg Schaede, Wurzburg (DE)

Correspondence Address: Clifford W Browning, Suite 3700, 111 Monument Circle, Indianapolis, IN, 46204-5137, US

(73) Assignee: KBA-GIORI S.A., Lausanne (CH)

(21) Appl. No.: 10/564,930

(22) PCT Filed: Jul. 15, 2004
(86) PCT No.: PCT/CH04/00453

§ 371 Date: Jan. 17, 2006

(30) Foreign Application Priority Data
Jul. 16, 2003 (DE) 103 32 212.4

(51) Int. Cl. B41F 5/00

(52) U.S. Cl. 101/216

(57) ABSTRACT

The invention relates to a device for checking the quality of articles to be checked, comprising a first inspection device which detects image data of a surface on the front side of the article to be checked and an evaluation device which evaluates the quality of the article to be checked based on the detection result of the inspection device. A second inspection device is provided for detecting a rear side of the articles to be checked and a third inspection device is provided for illuminating the articles to be checked.

The present invention relates to devices for checking the quality of sheets, comprising a first inspection device for detecting image data of a surface on the front side of the sheets and an evaluation device for evaluating the quality of the sheets based on the detection result of the inspection device.

In the production of banknotes and other security papers, very high requirements must be required regarding the printing quality in order to ensure as uniform a visual identity as possible of the papers in circulation, which makes it possible to reliably identify as forgeries any papers which differ even slightly from a standard visual identity. This uniform visual identity can be ensured only by means of rigorous quality control during production of the security papers, in which all those papers which differ even slightly from the norm are discarded. This quality control takes place before the concerned number of security papers which are printed on one sheet are provided with serial numbering and separated from one another.

Since even minimal differences in a single security paper make it necessary for the sheet to be discarded, a stack containing sheets discarded as faulty is difficult to distinguish from a stack containing good sheets. In the event of careless handling, therefore, it may happen that a stack containing discarded sheets is inadvertently numbered and cut, and thus faulty papers enter into circulation.

The object of the invention is to provide devices for checking the quality of articles to be checked and a method for checking the quality of sheets.

According to the invention, this object is achieved by a device of the type mentioned above, in which a second inspection device is provided for detecting a rear side of the sheets, a third inspection device is provided for illuminating the sheets, and each inspection device is assigned its own transport drum for transporting the sheets.

Some embodiments of the device are those in which
the transport drums are arranged one after the other in such a way that each sheet, after passing over the first transport drum, or respectively the second transport drum, is passed directly to the respective downstream transport drum;
the first or second inspection device comprises an image sensor and a light source for inspection by reflection;
the first or second inspection device comprises a device for detecting the intensity of fluorescence;
the transport drum on which the third inspection device is arranged has a transparent casing, the third inspection device comprises an image sensor and a light source for inspection by transmission, and the transmission light source is arranged within the transparent casing of the transport drum;
at least one numbering unit for applying serial numbering to the sheets is arranged downstream of the inspection devices;
all three transport drums are arranged in a pair of side frame panels, that is to say in a module;
the device comprises two inspection devices for inspecting the front and rear sides of the articles to be checked;
the two inspection devices each comprise an image sensor and a light source for inspection by reflection;
two inspection units for detecting the intensity of fluorescence are arranged in the device;
the inspection devices comprise a UV light source and a light sensor;
a magnetic field sensor is provided as a further inspection device;
the device comprises a further inspection device;
a marking device is arranged upstream of a numbering unit;
a marking device is arranged with a counter- pressure cylinder of a numbering unit;
a sheet to be checked is divided into columns and rows, and a marking device marks an edge region of a column and/or row in which the fault is located;
a sheet to be checked is divided into columns and rows, and a marking device marks a column and outputs the row number in which the fault is located;
a marking device is arranged in a marking module or in a numbering module which is arranged downstream of the module;
the marking device applies a marking as unusable to the sheet if the evaluation device deems the quality of said sheet to be insufficient;
the evaluation device is arranged to individually evaluate the quality of individual copies on the article to be checked, and the marking device is designed to apply the marking only to or in relation to copies which are deemed to be unusable;
the marking device applies the marking to the horizontal and vertical edge region of the sheet;
at least one numbering unit for applying numbering to the sheets is arranged in the numbering module;
the numbering unit comprises a plurality of digit wheels which are moved to the next position after each printing operation so as to print a changed number in the next printing operation, and comprises a device for monitoring the motion of the digit wheels and for stopping the device if no movement is detected between two printing operations;
two numbering units are arranged on a common counter-pressure cylinder;
the counter-pressure cylinder has two printing segments;
the numbering unit is arranged behind the inspection device in the conveying direction of the sheets, so as to apply the numbering only to those sheets which have passed the quality check carried out by the inspection device;
the device comprises a printing unit;
arranged downstream of the device is a sheet discharger having at least one stack for sheets which have been deemed to be of sufficient quality, and at least one stack for sheets which have been deemed to be of insufficient quality;
the marking device comprises a plurality of ink spray heads.

The device thus carries out a method comprising the following steps:
inspecting the sheets;
evaluating the quality of the sheets or individual copies on the sheets as sufficient or insufficient;
evaluating a printed image on the front and/or rear side of the sheets under reflected light;
evaluating a printed image on the sheets under transmitted light;
applying a marking as unusable to the sheets or copies which have been deemed to be of insufficient quality.

In particular, fluorescent and/or magnetic properties of the sheets can be evaluated, the sheets in the sheet discharger can be deposited on a good stack or a waste stack depending on the quality evaluation, and a numbering can be applied to sheets or copies on sheets which have been deemed to be of sufficient quality.

One advantage of the device and method is that it reliably prevents inadvertent further use of sheets discarded as unusable. To this end, the device according to the invention is equipped with a marking device which can be actuated to apply a marking as unusable to a sheet if the evaluation device has deemed the quality of the sheet to be insufficient.

The marking can be applied to all copies on the sheet, even to those which per se do not have any quality deficiencies, so as to ensure that the entire sheet cannot be further processed. Alternatively, the evaluation device may be designed to evaluate the quality of each copy on a sheet individually, with the marking device then advantageously being designed to apply the marking as unusable only to that copy or in relation to that copy on the sheet which has actually been deemed to be unusable.

Preferably, the device comprises two transport cylinders which transport the sheets with different sides facing outwards, and first inspection devices arranged with the two cylinders for inspecting the front, and respectively rear, side of the sheets. These inspection devices preferably each comprise an image sensor and a light source for inspection by reflection for detecting the printed image which is illuminated by the reflecting light source on each side of the sheet. As an alternative or in addition, there may be provided a UV light source and a light sensor which is suitable for detecting fluorescence produced by the UV light source on a sheet to be checked. Like the image sensor mentioned above, this light sensor can be of spatial resolution; it may even be identical to the image sensor. Alternatively, it may be a light sensor without spatial resolution, which provides only an indication of the intensity of the fluorescence in the part of the sheet illuminated by the UV light source. In order to detect special security features of banknotes, such as metal fibres incorporated in the sheets, the inspection devices may also be equipped with a magnetic field sensor which reacts to changes in a magnetic field that are brought about by metal objects introduced into the field.

A further inspection device may also be provided which comprises an image sensor and a transmission light source for transmitting light through the sheet to be examined.

Such an inspection device allows for example inspections of watermarks or correct registration of front and back prints on the sheets with respect to one another.

A sheet discharger of the device according to the invention preferably comprises at least one stack for sheets which have been deemed to be of sufficient quality, and at least one stack for sheets which have been deemed to be of insufficient quality, and can be actuated by the evaluation device to deposit a sheet on a stack for usable or unusable sheets depending on the evaluation result of said evaluation device.

The device is preferably equipped with a numbering unit so as to be able immediately to apply numbering to the copies on the sheets deemed to be usable.

Euro banknotes have on one side two respectively differently coloured prints of a serial number. In order to produce such prints using the device according to the invention, said device is preferably equipped with two numbering units for producing respectively one of the two prints.

Examples of embodiments of the invention are shown in the drawings and are described in more detail below.

### IN THE DRAWINGS

Each of FIG. 1-6 shows a schematic longitudinal section through a device.

FIG. 1 shows a basic configuration of the machine according to the invention. A first assembly of the machine is a sheet feeder 01. Articles to be processed, in this case sheets, are fed to this sheet feeder 01, in the form of a stack 02. A lifting table 03 of the sheet feeder 01 lifts the stack 02 until the uppermost sheet thereof reaches a predefined height at which it can be lifted from the stack 02 by means of horizontally displaceable suction cups and can be displaced laterally in the direction of a conveyor belt table 04. The belts of the latter convey a sheet, in particular a paper sheet, until it comes into contact with a suction roll 06, to which the sheet adheres and the rotation of which is controlled in order to further convey the sheet to a transport cylinder 07, in such a way that the leading edge of the sheet can be gripped by grippers of the transport cylinder 07.

Arranged after the conveyor belt table 04 or a sheet feeder is an inspection module 31. The inspection module 31 comprises four transport drums 32; 33; 34; 36, also referred to here as transport cylinders 32; 33; 34; 36, which are held between side frame panels 11. The side frame panels 11 of the inspection module 31 are respectively fixed at one side to those of the conveyor belt table 04 and at another side to those of a downstream numbering module 08. Since neither the side frame panels 11 of the inspection module 31 nor those of the conveyor belt table 04 reach to the floor, they are supported by columns 35.

The transport cylinder 32 forms a sheet input interface which accepts sheets from the transport cylinder 07 of the sheet feeder. A first inspection device A arranged on the transport cylinder 32 comprises a light source 37 for illuminating an outer side of the sheet on the cylinder 32 and a camera 38 for scanning the region of the sheet surface that is illuminated by the light source 37, and also a housing 39 in which the light source 37 and the camera 38 are accommodated in order to shield them from ambient light. A computer (not shown in the figure) which is connected to the camera 38 compares the image of the sheet recorded by the camera 38 with a desired printed image stored in electronic form, and decides whether the correspondence between the detected printed image and the desired printed image is good enough for the quality of the sheet to be deemed sufficient. Also arranged with the cylinder 32 is a UV inspection device B comprising a UV light source and a light sensor which is insensitive to the UV light of the light source but detects fluorescence of the sheet that is produced by said light source. The intensity of fluorescence is also compared with a desired value by means of the control unit (not shown) in order to assess the quality of the sheet.

After passing over the cylinder 32, the sheet is transferred to the subsequent transport cylinder 33. On this transport cylinder 33, that side of the sheet which faced the cylinder 32 now faces outwards. The same inspection devices A; B which are arranged with the cylinder 32 are also provided with the cylinder 33, so as to be able to check the quality of both sides of the sheet in the same way.

After passing over the cylinder 33, the sheet reaches the cylinder 34, within the transparent casing of which a light source 42 is arranged. A camera 44 which is once again accommodated in a housing 43 that is shielded from scattered light scans the region of the sheet which is illuminated by the light source 42, and the control unit also compares the image supplied by this camera 44 with a desired image. The transmitted light inspection device C comprising the light source 42, the housing 43 and the camera 44 permits the detection of registration errors between the prints on the front and rear sides of the sheets.

A magnetic field sensor (not shown), which may be formed for example by a permanent magnet or an electromagnet and a Hall sensor, can be arranged on any transport cylinder 32; 33; 34; 36 of the inspection module 31. It allows the detection of metal fibres or other metallic elements which are incorporated as a security feature in many modern banknotes.

The last transport cylinder 36 of the inspection module 31 forms the sheet transfer interface thereof to the subsequent numbering module 08.

The numbering module 08 comprises a plurality of cylinders 17; 18; 19, which, like the cylinders 32; 33; 34; 36 of the inspection module 31, are rotatably held in side frame panels 09. The side frame panels 09 of the numbering module 08 have a cut-out in which the side frame panels 11 of the inspection module 31 engage, so that the latter are supported by the side frame panels 09. The side frame panels 09; 11 are respectively fixed to one another.

The transport cylinder 36 transfers the sheets to a transport cylinder 17 of the numbering module 08. The latter passes them to a counter-pressure cylinder 18. A marking device 46 and two numbering units 21; 22 are arranged on the counter-pressure cylinder 18, wherein the marking device 46 is arranged upstream of the numbering unit 21; 22. In order to be able to accommodate this marking device 46 and the two numbering units 21; 22 at the circumference of the counter-pressure cylinder 18, the diameter of the latter is selected to be twice as great as that of the transport cylinders 07; 32; 33; 34; 36; 17.

As a sheet passes through the various inspection devices A; B; C of the inspection module 31 and then is transported into the numbering module 08 to the counter- pressure cylinder 18, the computer evaluates the results of the various inspection devices A; B; C and decides whether the quality of the sheet or of the individual banknotes printed on the sheet is sufficient. If it is, the two numbering units 21; 22 print respective identical serial numbers at two respective locations on each banknote printed on the sheets passing through. In principle, it would also be possible to produce two such prints using a single numbering unit 21; 22; however, the use of two numbering units 21; 22 makes it possible to print the numbering at the two locations in respective different colours.

The numbering cylinders 19 of the numbering units 21; 22 have on their circumference, distributed in the longitudinal and circumferential direction in a manner corresponding to the arrangement of the banknotes on the sheets, a plurality of number-printing units each with a plurality of rotatable digit wheels, which each have on their circumference all the printable digits and which print a serial number in a manner dependent on the orientation of the individual digit wheels. During normal operation of the machine, the digit wheels are moved to the next position after each printing operation, so that serial numbers are printed onto the sheets. A malfunction sensor is provided on each number-printing unit in order to detect whether the digit wheels have or have not moved between two printing operations carried out on successive sheets. If no motion is detected, a malfunction has occurred and the device is stopped.

If the computer ascertains that the quality of a sheet or of an individual banknote on a sheet is insufficient, it actuates the marking device 46 which is arranged with the counter-pressure cylinder 18. The marking device 46 comprises a number of inkjet spray heads, each of which is directed towards a column of banknotes printed on the sheets. By means of this marking device 46, the column is marked and the row number in which the faulty banknote is located is output. It is also possible to spray a marking onto a banknote deemed to be of insufficient quality at the moment at which said banknote passes in front of the marking device 46. It is also conceivable to actuate the spray heads of the marking device 46 respectively at a moment at which a non-printed front or rear edge of a sheet deemed to be faulty passes through in front of the marking device 46, in order thus to mark a column on the sheet which contains a faulty banknote. The fault is in this way not hidden by the marking and can be examined by maintenance staff. In this variant, it may be advantageous to provide an additional spray head in the marking device 46 in order thus to place a marking on a non-printed side edge of the sheet at the same level as a row which contains the faulty banknote, so that the banknote deemed to be faulty, which is located at the point of intersection of the marked row and column, can be immediately identified by an observer.

If the computer detects that a sheet contains a faulty banknote, it also controls the numbering units 21; 22 so that these allow the sheets to pass without printing any numbers thereon. Consequently, the numbering units 21; 22 do not move their numbers as the faulty sheet passes through, so that a subsequent, fault-free sheet is respectively allocated numbers which directly follow on from those of a previously numbered sheet.

Once the sheets on the counter-pressure cylinder 18 have passed both the numbering cylinders 19, they are picked up at a transfer cylinder 23 by a chain conveyor which feeds them via a connecting frame 24 to a sheet discharger 26. The sheet discharger 26 has a modular design with a plurality of stacks 27; 28; 29 on which the sheets can optionally be deposited. Depending on the result of the quality evaluation, the computer actuates the discharger 26 to deposit a sheet on one of two stacks 27; 28 provided for usable sheets or on a waste stack 29.

The sheets deposited on the stacks 27; 28 for usable sheets are thus continuously numbered in any case, so that they can then be cut into individual banknotes and the banknotes can be combined into continuously numbered packs and sealed, without any manual corrective intervention being necessary.

When one of the stacks 27; 28, in this case the stack 27, is full, the sheet discharger 26 automatically switches to another stack 28, so that the full stack 27 can be moved away without having to interrupt the processing operation.

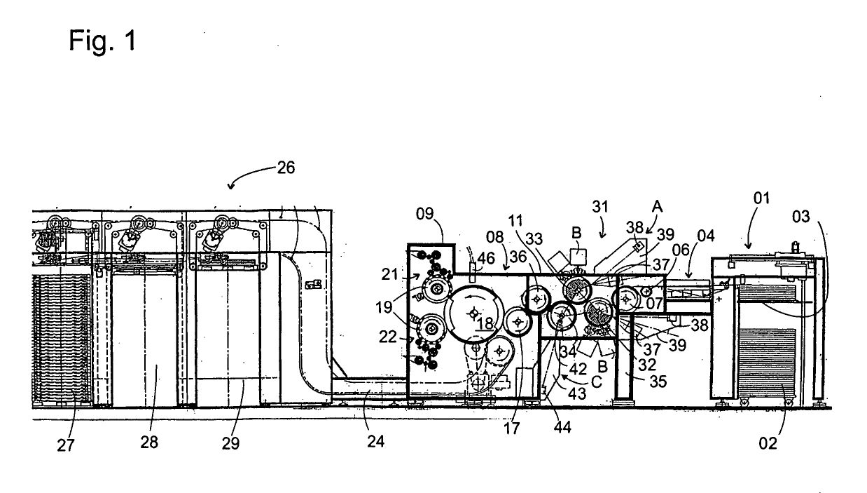

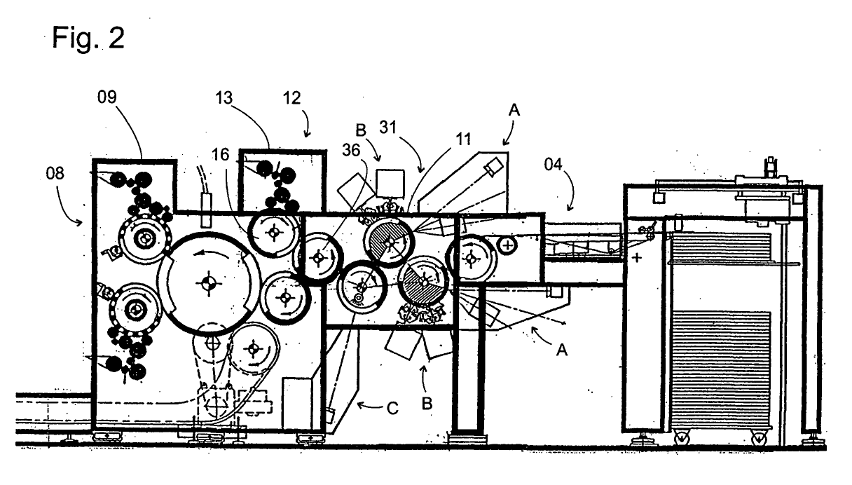

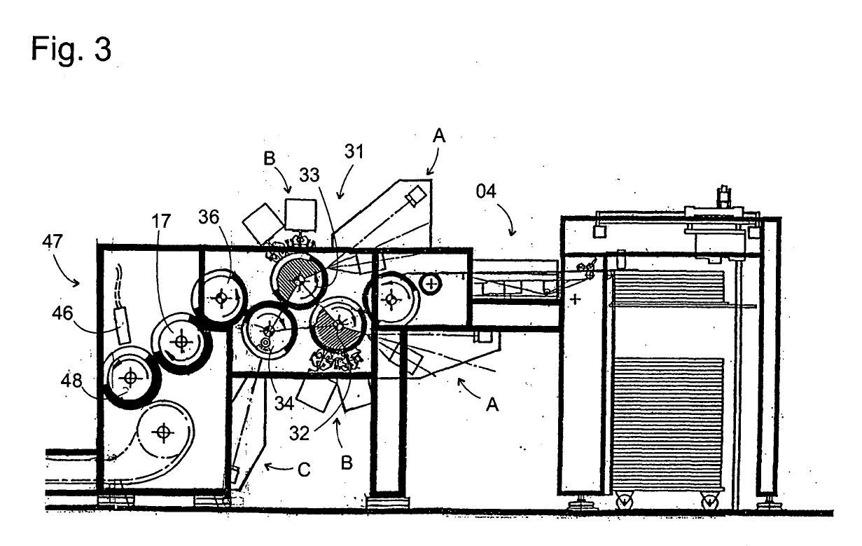

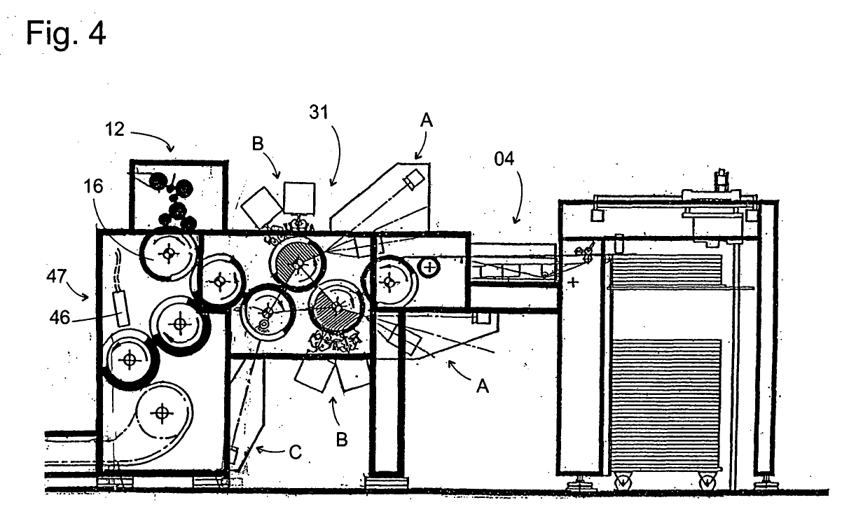

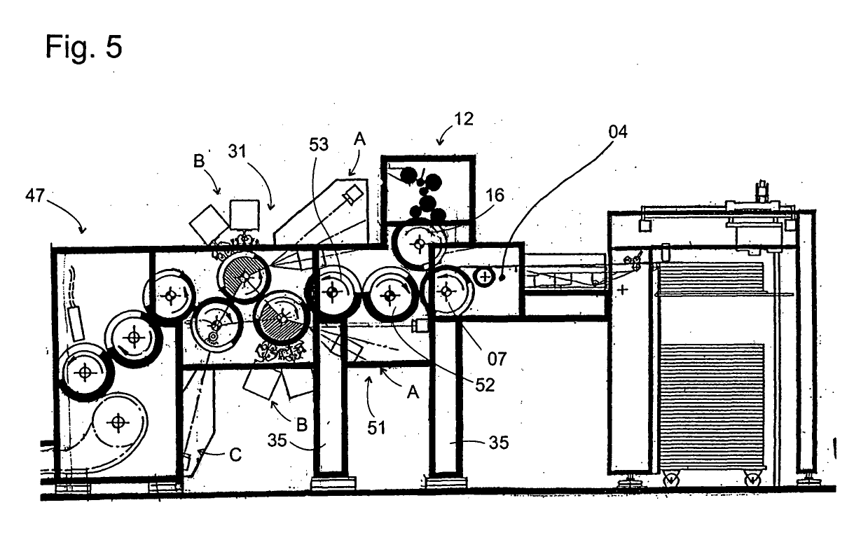

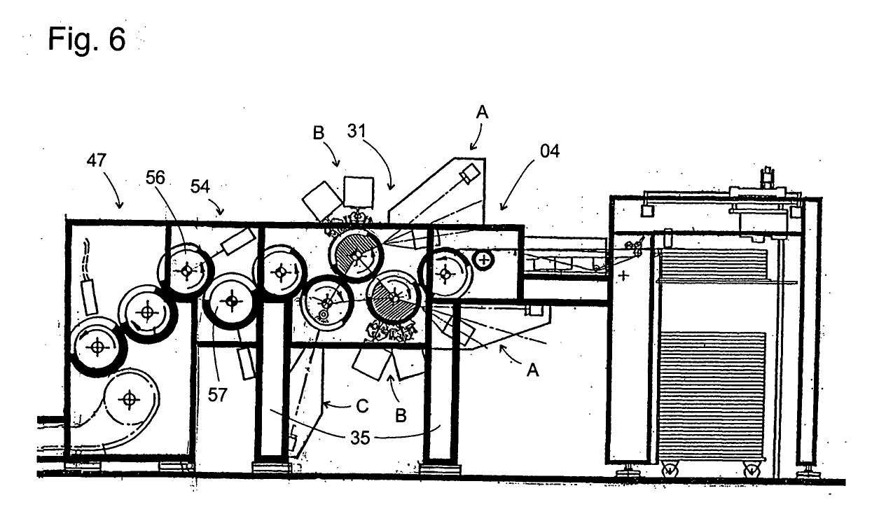

FIG. 2 shows a modified configuration of the processing device of FIG. 1. Parts of this configuration which correspond to those already described with reference to FIG. 1 bear the same references and are not described again. The sheet discharger 26 is identical to that shown in FIG. 1 and is not shown again in FIG. 2.

In the configuration of FIG. 2, the numbering module 08 is additionally equipped with a printing unit. The printing unit is composed of an inking unit 12 placed on the numbering module 08, said inking unit comprising a plurality of rolls which are suspended between side frame panels 13, and of a form cylinder 16 which is supplied with colour by the inking unit. The side frame panels 13 rest on the side frame panels 09; 11 and are fixed to the latter. The form cylinder 16 of the printing unit has an axis which lies at the same height as the side frame panels 09 of the numbering module 08, and delimits a printing nip together with the transport cylinder 36. The numbering module 08 comprising the form cylinder 16 and the inking unit 12 can thus also be considered as a printing module. This printing module can be used to print any detail still missing onto sheets already comprising a preprinted basic pattern and which have been removed from the stack of the sheet feeder 01. This is particularly advantageous when producing banknotes, the basic pattern of which is printed in high numbers and in a manner which usually has remained completely unchanged for many years, but which has certain details which vary at relatively short time intervals, such as for example the signature of a Chairman of a central bank which issues the banknotes. The printing module is highly suitable for printing such a signature onto banknotes which have otherwise been preprinted.

In the simplified modification shown in FIG. 3, the numbering module 08 is replaced by a marking module 47. This marking module 47 has as sheet input interface a transport cylinder 17 which is identical to the cylinder 17 of the numbering module 08 and is arranged at the same position as the latter. The transport cylinder 17 passes the sheets to a transport cylinder 48 which, unlike the counter-pressure cylinder 18, has the same diameter as the cylinders 17; 32; 33; 34; 36, etc. The marking device 46 described with reference to FIG. 1 is arranged on this transport cylinder 48 at a suitable position. The mode of operation of the marking device 46 is the same as that described with reference to FIG. 1; in this case, too, sheets marked as unusable by means of a marking are discarded onto the waste stack 29 by the sheet discharger 26.

As shown in FIG. 4, the printing unit can be mounted on the marking module 47 in the same way as on the numbering module 08.

In the configurations of FIGS. 2 and 4, the sheets pass through the inspection module 31 in each case before the printing unit, so that the quality of the print produced by the latter can no longer be checked by the inspection module 31. As shown in FIG. 5, this problem can be eliminated by adding a transport module 51 between the conveyor belt table 04 and the inspection module 31, which transport module essentially has the function of serving as a carrier for the printing unit. The transport module 51 contains two transport cylinders 52, 53, which respectively form the sheet input interface and the sheet output interface of the module. The purpose thereof is essentially only to convey the sheets between the conveyor belt table 04 and the inspection module 31 over a distance which is necessary in order to be able to accommodate the printing unit between the conveyor belt table 04 and the inspection module 31. In this configuration, the form cylinder 16 of the printing unit cooperates with the transport cylinder 07 of the conveyor belt table 04.

FIG. 6 shows a further configuration in which an expansion module 54 comprising two transport cylinders 56; 57 is furthermore added between the inspection module 31 and the marking module 47. The expansion module 54 can serve as a carrier for any further functional groups for carrying out processing steps on the sheets. It may for example serve as a carrier for further inspection devices for which there is no space on the inspection module 31, as a carrier for a printing unit, for laser marking devices, etc. It would also be conceivable to form the inspection module 31 from two expansion modules, wherein reflected light inspection devices A could be fitted on one of these and the transmitted light inspection device C could be fitted on the second of said expansion modules. The cameras 38; 44 have each a CCD sensor.

### LIST OF REFERENCES

01 sheet feeder
03 stack
03 lifting table
04 conveyor belt table
05 -
06 suction roll
07 transport cylinder
08 numbering module
09 side frame panels
10 -
11 side frame panels
12 inking unit
13 side frame panels
14 -
15 -
16 form cylinder
17 cylinder, transport cylinder
18 cylinder, counter-pressure cylinder
19 cylinder, numbering cylinder
20 -
21 numbering unit
22 numbering unit
23 transfer drum, transfer cylinder
24 connecting frame
25 -
26 discharger, sheet discharger
27 stack
28 stack
29 stack, waste stack
30 -
31 inspection module
32 cylinder, transport cylinder, transport drum
33 cylinder, transport cylinder, transport drum
34 cylinder, transport cylinder, transport drum
35 column
36 cylinder, transport cylinder, transport drum
37 light source, light source for inspection by reflection
38 camera, image sensor
39 housing
40 -
41 -
42 light source
43 housing
44 camera
45 -
46 marking device
47 marking module
48 cylinder, transport cylinder
49 -
50 -
51 transport module
52 cylinder, transport cylinder
53 cylinder, transport cylinder
54 expansion module
55 -
56 transport cylinder
57 transport cylinder
A first inspection device
B second inspection device, UV
C third inspection device, transmitted light

1. Device for checking the quality of sheets, wherein each sheet comprises a plurality of copies, comprising a first inspection device for detecting image data of a surface on the front side of the sheets, a second inspection device for detecting image data of a surface on the rear side of the sheets, a third inspection device for illuminating the sheets and an evaluation device for evaluating the quality of the sheets based on the detection result of the inspection devices, wherein each inspection device is assigned its own transport drum for transporting the sheets.

2. Device according to claim 1, wherein the transport drums are arranged one after the other in such a way that each sheet, after passing over the first transport drum or second transport drum, is passed directly to the respective downstream transport drum.

3. Device according to claim 1, wherein the first or second inspection device comprises an image sensor and a light source for inspection by reflection.

4. Device according to claim 1, wherein the first or second inspection device comprises a device for detecting the intensity of fluorescence.

5. Device according to claim 1, wherein the transport drum with which the third inspection device is arranged has a transparent casing, wherein the third inspection device comprises an image sensor and a light source for inspection by transmission, and wherein the transmission light source is arranged within the transparent casing of the transport drum.

6. Device according to claim 1, wherein all three transport drums are arranged in a pair of side frame panels.

7. Device according to claim 1, wherein at least one numbering unit for applying serial numbering to the sheets is arranged downstream of the inspection devices.

8. Device according to claim 7, wherein a marking device is arranged on a counter-pressure cylinder of the numbering unit.

9. Device according to claim 8, wherein the marking device is arranged upstream of the numbering unit.

10. Device according to claim 7, wherein two numbering units are arranged on a common counter-pressure cylinder.

11. Device according to claim 7, wherein the numbering unit applies the numbering only to those sheets which have passed the quality check carried out by the inspection devices.

12. Device according to claim 11, wherein the numbering unit comprises a plurality of digit wheels which are moved to the next position after each printing operation so as to print a changed number in the subsequent printing operation, and wherein the motion of the digit wheels is stopped if a sheet is deemed to be unusable.

13. Device according to claim 7, wherein the numbering unit comprises a plurality of digit wheels which are moved to the next position after each printing operation so as to print a changed number in the subsequent printing operation, and wherein a device is provided for monitoring the motion of the digit wheels and for stopping the device if no movement is detected between two printing operations.

14. Device according to claim 1, wherein a marking device is arranged downstream of the inspection devices.

15. Device according to claim 1, comprising a marking device and wherein a sheet to be checked is divided into columns and rows, and wherein the marking device marks an edge region of a column and/or row in which the fault is located.

16. Device according to claim 1, comprising a marking device and wherein a sheet to be checked is divided into columns and rows, and wherein the marking device marks a column and outputs the row number in which the fault is located.

17. Device according to claim 1, comprising a marking device and wherein the marking device applies a marking as unusable to the sheet if the evaluation device deems the quality of said sheet to be insufficient.

18. Device according to claim 1, comprising a marking device and wherein the evaluation device is designed to individually evaluate the quality of individual copies, and wherein the marking device is designed to apply the marking only to or in relation to copies which are deemed to be unusable.

19. Device according to claim 1, comprising a marking device and wherein the marking device applies the marking to the horizontal and vertical edge region of the sheet.

20. Device according to claim 1, comprising a marking device and wherein the marking device comprises a plurality of ink spray heads.

21. Device according to claim 1, wherein arranged downstream of the device is a sheet discharger having at least one stack for sheets which have been deemed to be of sufficient quality, and at least one stack for sheets which have been deemed to be of insufficient quality.

22. Device according to claim 1, wherein a further transport drum is arranged downstream of the three transport drums of the inspection devices, which transport drum forms a sheet transfer interface.

23. Device according to claim 22, wherein the three inspection devices and the four transport drums form an inspection module which can be connected to other modules.

24. Device according to claim 22, wherein the further transport drum also serves as counter-pressure cylinder.

25. Device according to claim 1, wherein a magnetic field sensor is arranged on one of the transport drums.

26. Device according to claim 1, wherein a printing unit is arranged upstream or downstream of the inspection devices.

27. Device according to claim 26, wherein the printing unit comprises an inking unit and a form cylinder which is supplied with colour by the inking unit.
